(19) United States
(12) Patent Application Publication
(10) Pub. No.: US 2017/0248224 A1
(43) Pub. Date: Aug. 31, 2017

(54) PUSHBUTTON VEHICLE SHIFTER INTERFACE USING PROXIMITY SENSING

(71) Applicant: Ford Global Technologies, LLC, Dearborn, MI (US)

(72) Inventors: Pietro Buttolo, Dearborn Heights, MI (US); James Stewart Rankin, II, Novi, MI (US); Mark McCarthy, Ann Arbor, MI (US); Stuart C. Salter, White Lake, MI (US)

(73) Assignee: Ford Global Technologies, LLC

(21) Appl. No.: 15/596,179

(22) Filed: May 16, 2017

Related U.S. Application Data
(63) Continuation of application No. 15/040,370, filed on Feb. 10, 2016.

(51) Int. Cl. F16H 59/12; F16H 59/02; B60K 20/08

(52) U.S. Cl. CPC F16H 59/12; B60K 20/08; F16H 59/0217; F16H 2059/026

(57) ABSTRACT

A pushbutton shifter interface is provided that includes a movable assembly supporting a plurality of pushbutton keys. The pushbutton shifter interface also includes a proximity sensor arrangement configured to sense a user proximate the pushbutton keys and interfacing with one of the keys and an actuator actuating the movable assembly to a use position in response to sensing the user proximate the pushbutton keys. The pushbutton shifter interface further includes a display showing a sensed position of the user relative to the plurality of pushbutton keys.

### CROSS-REFERENCE TO RELATED APPLICATION

This application is a continuation of U.S. patent application Ser. No. 15/040,370 filed Feb. 10, 2016, entitled “PUSHBUTTON VEHICLE SHIFTER INTERFACE USING PROXIMITY SENSING.” The aforementioned related application is hereby incorporated by reference.

### FIELD OF THE INVENTION

The present invention generally relates to pushbutton shifter interfaces for vehicles, and more particularly relates to an enhanced pushbutton shifter interface that employs proximity sensing.

### BACKGROUND OF THE INVENTION

Automotive vehicles are typically equipped with a shifter interface for selecting the various operating modes of a vehicle including park, reverse, neutral, drive and low gear selections. Some automotive vehicles have replaced the conventional gear shifters with shift-by-wire systems that employ user interface inputs such as pushbuttons. It would be desirable to provide for an enhanced operation of a pushbutton shifter interface for use on a vehicle.

### SUMMARY OF THE INVENTION

According to one aspect of the present invention, a pushbutton shifter interface is provided. The pushbutton shifter interface includes a movable assembly supporting a plurality of pushbutton keys actuatable to input a vehicle operating mode and a proximity sensor arrangement configured to sense a user proximate the pushbutton keys. The pushbutton shifter interface also includes an actuator actuating the movable assembly to a use position in response to sensing the user proximate to the pushbutton keys in a stowed position.

According to another aspect of the present invention, a pushbutton shifter interface is provided that includes a plurality of pushbutton keys actuatable to input a vehicle operating mode and a plurality of proximity sensors configured to sense a position of a user proximate the pushbutton keys. The pushbutton shifter interface also includes a display showing the sensed position of the user relative to the plurality of pushbutton keys.

According to a further aspect of the present invention, a pushbutton shifter interface is provided that includes a movable assembly supporting a plurality of pushbutton keys and a proximity sensor arrangement configured to sense a user proximate the pushbutton keys and interfacing with one of the keys. The pushbutton shifter interface also includes an actuator actuating the movable assembly to a use position in response to sensing the user proximate the pushbutton keys and a display showing a sensed position of the user relative to the plurality of pushbutton keys.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a perspective view of a passenger compartment of an automotive vehicle having a pushbutton shifter interface with proximity sensors, according to one embodiment;

FIG. 1A is an enlarged perspective view of the pushbutton shifter interface shown in a forward use position;

FIG. 2 is a perspective view of the pushbutton shifter interface shown in a stowed position;

FIG. 3 is a top view of the pushbutton shifter interface of FIG. 2 illustrated in the stowed position;

FIG. 3A is a top view of the pushbutton shifter interface of FIG. 2 illustrated in the forward use position;

FIG. 4 is a top view of one of the pushbutton keys employing capacitive proximity sensing, according to one embodiment;

FIG. 4A is a cross-sectional view taken through line IVA-IVA of FIG. 4;

FIG. 5 is a top view of a pushbutton key employing an alternative capacitive proximity sensing arrangement, according to another embodiment;

FIG. 5A is a cross-sectional view taken through line VA-VA of FIG. 5;

FIG. 6 is a schematic view of a user interfacing with the pushbutton keys, according to a capacitive sensing embodiment;

FIG. 7 is a graph illustrating signals associated with the capacitive sensors generated while a user interfaces with the pushbutton keys;

FIG. 8 is a graph illustrating signals associated with the capacitive sensors while a user pauses on a pushbutton key;

FIG. 9 is a graph illustrating signals associated with the capacitive sensors when a user presses to activate one of the pushbutton keys;

FIG. 10 is a perspective view of a pushbutton shifter interface employing infrared sensors with the pushbutton keys shown in a stowed position, according to another embodiment;

FIG. 10A is a perspective view of the pushbutton shifter interface of FIG. 10 with the pushbutton keys shown in a forward use position;

FIG. 10B is a perspective cross-sectional view of the pushbutton shifter interface taken through line XB-XB of FIG. 10A;

FIG. 11 is a top view of a pushbutton shifter interface employing an actuator that slides the plurality of pushbutton keys forward relative to a housing, according to another embodiment;

FIG. 11A is a top view of the pushbutton shifter interface of FIG. 12 illustrating the pushbutton keys extended forward in a use position;

FIG. 12 is a front view of an interactive display illustrating the PRNDL vehicle operating modes in the instrument cluster;

FIG. 12A is a front view of the display illustrating an enlarged representation of one key and the user's finger illustrated interfacing with that key;

FIG. 13 is a block diagram illustrating the control arrangement for the pushbutton shifter interface;

FIG. 14 is a flow diagram illustrating a routine for providing the pushbutton shifter proximity sensing and controlling the interactive display; and

FIG. 15 is a flow diagram illustrating a routine for controlling the movement and position of the pushbutton shifter interface assembly.

### DETAILED DESCRIPTION OF THE PREFERRED EMBODIMENTS

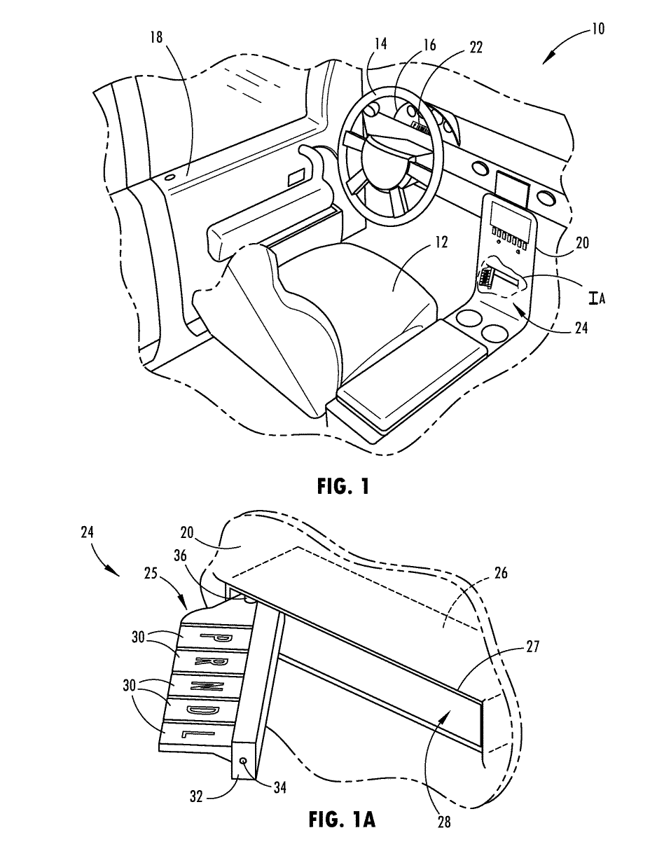

Referring to FIGS. 1 and 1A, the interior passenger compartment of an automotive vehicle 10 is generally illustrated having a pushbutton shifter interface 24, according to one embodiment. The vehicle 10 is shown generally equipped with a driver's seat 12 positioned rearward of a steering wheel 14 and accessible to a driver via a passenger door 18, according to a conventional seating arrangement in a vehicle. The pushbutton shifter interface 24 is shown located in a forward panel 20, such as an instrument panel, and is generally within reach and accessible to the driver of the vehicle seated in the driver seat 12. The pushbutton shifter interface 24 includes a plurality of pushbutton keys 30 that enable the driver to input a vehicle operating mode, such as the transmission gear mode including park, reverse, neutral, drive and low, also referred to as a PRNDL input.

The pushbutton shifter interface 24 includes a movable assembly 25 configured as a moving platform that supports the plurality of pushbutton keys 30, each of which are actuatable as user inputs to input one of the vehicle operating modes. The pushbutton shifter interface 24 also includes a proximity sensor arrangement configured to sense a user, such as the driver of the vehicle, proximate the pushbutton keys 30. An actuator actuates the movable assembly 25 to a use position in response to sensing the user in contact or close proximity to the pushbutton keys 30. In addition, a display 22 within the instrument cluster 16 shows the operating modes represented by icons, the selection of the current mode, and the position of the user's finger relative to the pushbutton keys 30. The display 22 may be a digital display located in the instrument cluster 16 generally forward of the steering wheel 14 and viewable by a driver seated in the driver seat 12. The display 22 displays the available operating modes with separate icons P, R, N, D, and L, the current selected operating mode in an enlarged, highlighted or lighted representation, and an indication that a user is interfacing with the pushbutton shifter interface 24 by indicating which pushbutton key the user is presently sensed interfacing therewith.

By employing the proximity sensor arrangement, the pushbutton shifter interface 24 provides improved user interface performance. In one implementation, the proximity sensing enables the display to display 22 to the driver the key 30 upon which the driver's finger is exploring, before and while an actual actuation of a pushbutton key 30 is performed. In another implementation, the proximity sensor arrangement enables the actuator to actuate the movable assembly 25 to a use position, such as a position forward of a stowed position that enables enhanced access to the pushbutton keys 30 by the driver of the vehicle seated in the driver seat 12. The actuator may actuate the movable assembly forward of the instrument panel 20 and/or may also rotate or actuate the assembly 25 to an angle better suited for interfacing with the keys 30 by the driver.

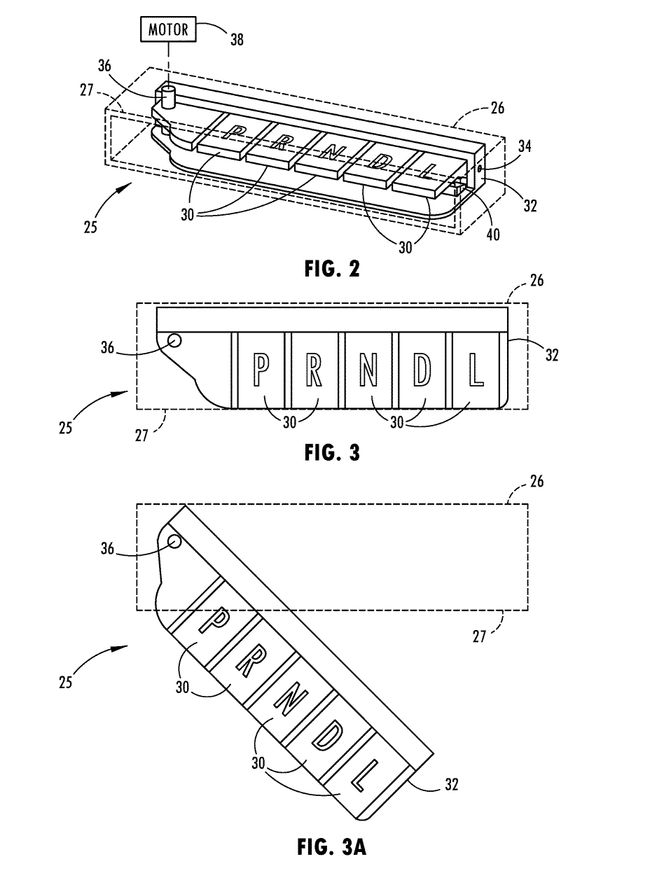

In the embodiment shown in FIGS. 1-9, a rotating pushbutton shifter interface 24 is provided with movable assembly 25 that rotates forward and at an angle relative to the driver to a use position as seen in FIG. 1. The pushbutton shifter interface 24 has a plurality of pushbutton keys 30 supported by a rear frame 32 and pivot rod 34 as part of the movable assembly 25. The pushbutton keys 30 may be in a stowed position within or partially within a tray or housing 26 in the instrument panel 20 and deployed outward by an actuator shown as motor 38 rotating and moving the assembly 25 forward about pivot shaft 36 to pivot the assembly 25 towards the driver to a use position. The pushbutton shifter interface 24 is illustrated in FIGS. 1A-3A having five distinct pushbutton keys 30 supported by the frame 32 and pivot rod 34 on movable assembly 25. The pushbutton keys 30 are connected and pivot relative to the interconnecting rod 34 within frame 32. Each key 30 has an indicia printed or formed on a top surface indicative of a selectable operating mode, such as one of the PRNDL operating modes. The pushbutton keys 30 are mechanically actuated downward by force applied by a user and include a pliable return member that returns the key 30 with a bias force to the upward position. Each key 30 is actuatable by pushing downward with sufficient force to a position where a switch is activated to generate a mode selection input signal. In addition, the housing 26 has a top surface 27 that overhangs at least a portion of the keys in the stowed positon and thereby forms a cover or brow that is disposed at least partially above the plurality of pushbutton keys 30 which serves to prevent inadvertent activations of the pushbutton keys 30. To allow activations or to sense activation of the key 30, the top overhanging surface 27 preferably only partially overlaps the plurality of keys 30.

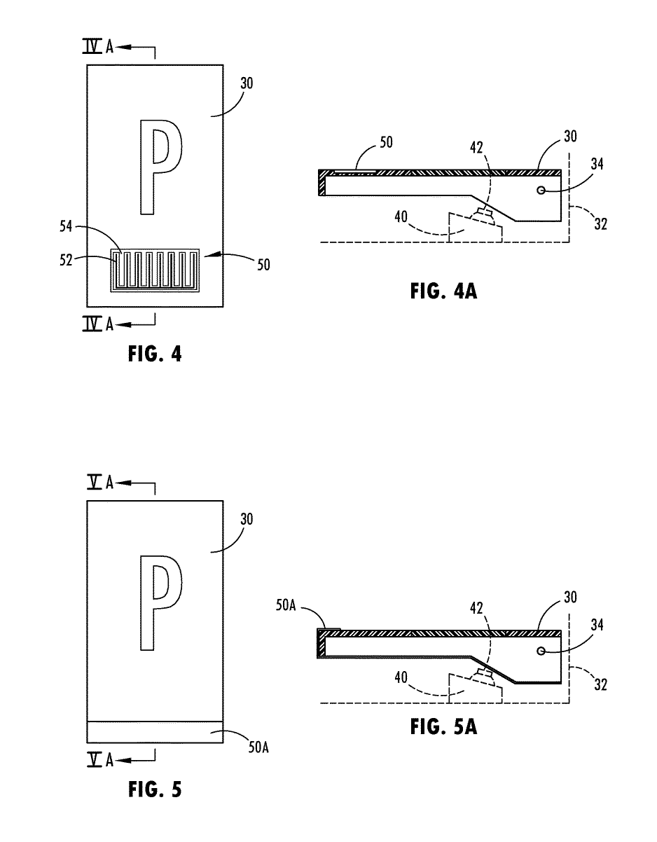

Each of the plurality of pushbutton keys 30 includes a proximity sensor 50 such as is shown in FIG. 4 as part of the proximity sensor arrangement that senses a user (e.g., a human finger) in contact with or in close proximity to the corresponding pushbutton key 30. According to one embodiment, the proximity sensors 50 comprise capacitive sensors. The capacitive sensors each may be configured having a drive electrode 52 and a receive electrode 54 each having interdigitated conductive fingers for generating a capacitive field. One example of the interdigitated fingers of the capacitive sensor illustrated in FIG. 4. The proximity sensor 50 may be formed by printing conductive ink onto the top surface of a polymeric pushbutton key 30 or onto a bottom surface thereof. It should be appreciated that the proximity sensor 50 may otherwise be formed such as by assembling preformed conductive circuit trace onto a substrate, according to other embodiments. The drive electrode 52 may receive square wave drive pulses applied at a voltage, while the receive electrode 54 has an output for generating an output voltage. It should be appreciated that the electrodes 52 and 54 may be arranged in various other configurations for generating the capacitive field as the activation field. The drive electrode 52 may be applied with a voltage input as square wave pulses having a charge pulse cycle sufficient to charge the receive electrode 54 to a desired voltage. The receive electrode 54 thereby serves as a measurement electrode. When a user or operator, such as the user's finger, enters the activation field, the proximity sensor 50 detects a disturbance caused by the finger to the activation field and a controller determines whether the disturbance is sufficient to activate the corresponding proximity sensor. The disturbance of the activation field is detected by processing the charge pulse signal associated with the corresponding signal channel. Each proximity sensor has its own dedicated signal channel generating charge pulse counts which are processed to determine a sensed condition. A controller or control circuitry may be included to process the activation field of each sensor to sense user activation of the corresponding sensor by comparing the activation field signal to one or more thresholds. It should be appreciated that analog and/or digital control circuitry may be employed to process each activation field, determine user proximity sensing, and initiate a control action. The control circuitry may employ a QMatrix acquisition method available by ATMEL®, according to one embodiment. According to another embodiment, a QTouch capacitive sensing technology may be employed in which a single data acquisition channel may be used for each sensor. With the QMatrix configuration, touch is detected using a scanned passive matrix of electrode sets. A single QMatrix device can drive a large number of keys. Other capacitive sensor technology such as mTouch may be employed.

In FIG. 5, an alternative capacitive sensing technique is shown employing a chrome sensor 50A formed on a top forward edge of each pushbutton key 30 and extending onto the bottom surface thereof. The use of a metal ornament as the sensor 50A on the top forward edge of the key 30 can be used as a capacitive sensor. The chrome sensor 50A can extend underneath to the bottom and back of the pushbutton key 30 to conduct the signal to a processor or other control circuitry, or a flex connector/conductive foam could be used. The capacitive sensor 50A on each of the pushbutton keys 30 generates a delta signal count which may be processed to determine the location or proximity of a user relative to the pushbutton shifter interface.

The pushbutton keys 30 are arranged in a lateral “piano-key” style arrangement. Each pushbutton key 30 as shown in FIGS. 4A and 5A has a horizontally aligned rocker-style button that pivots at rod 34 near the extremity away from the user. The rocker-style pushbutton key 30 includes a resilient elastomeric dome 40 and a switch 42 mounted thereon below the key 30. The elastomeric dome 40 is fixed to the housing 32 below the key 30 and serves to provide an upward bias force. Alternatively, a coil spring or other bias force mechanism could be employed. As the user depresses the pushbutton key 30, the key 30 pivots about the pivot rod 34 and activates the switch 42 and depresses the elastomeric dome 40. When the switch 42 is activated, a signal is output indicative of actuation of the key 30. The elastomeric dome 40 is resilient such that it pushes the pushbutton key 34 back to its upward position upon removal of the user's finger from the key 30. It should be appreciated that other configurations of the pushbutton key 30 may be used in connection with the pushbutton shifter interface 24. It should also be appreciated that proximity switches, such as capacitive switches, could be used in place of the mechanical pushbutton keys, according to other embodiments.

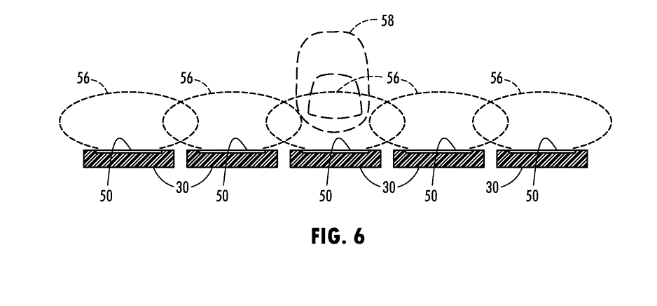

Referring to FIG. 6, a user's finger 58 is shown interacting with the pushbutton shifter interface 34. In this embodiment, the pushbutton shifter interface 24 employs capacitive proximity sensors 50, each of which generates an activation field 56. As the user's finger or other body part interacts with the activation field 56 for a corresponding proximity sensor 50, a signal is generated and processed by control circuitry to detect the finger in contact or close proximity to the corresponding pushbutton key 30. The user, such as the user's finger 58, may touch or come into close contact with the proximity sensor 50 sufficient to trigger detection of the finger 58 intending to interface with the pushbutton shifter interface 24. When the user initially interfaces with the pushbutton shifter interface 24, the movable assembly 25 with the pushbutton keys 30 may be actuated forward to a use position. In addition, the position of the user's finger 58 may be displayed on a display 22 to present the user with a view of the finger position relative to the keys, and the display is presented in a region generally forward of a driver of the vehicle.

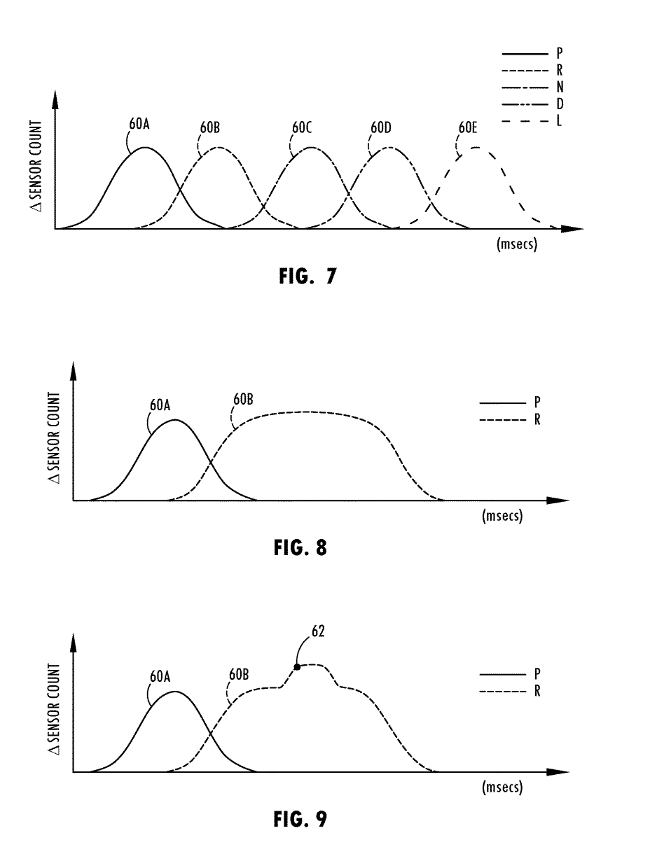

Referring to FIGS. 7-9, signals 60A-60E showing the change in sensor charge pulse count shown as 4 sensor count for a plurality of signal channels associated with the five proximity sensors 30 is illustrated, according to various examples. The change in sensor charge pulse count is the difference between an initialized reference count value without any finger or other object present in the activation field and the corresponding sensor reading. In these examples, the user's finger enters an activation field 56 associated with one of the proximity sensors as the user's finger moves across the pushbutton shifter interface 24. The signal channel is the change (4) in sensor charge pulse count associated with the capacitive sensor 50 associated with the corresponding pushbutton key 30. In the disclosed embodiment, the proximity sensors 50 are capacitive sensors. When a user's finger is in contact with or close proximity to a sensor 50, the finger alters the capacitance measured at the corresponding sensor 50. The capacitance is in parallel to the untouched sensor pad parasitic capacitance, and as such, measures as an offset. The user or operator induced capacitance is proportional to the user's finger or other body part dielectric constant, the surface exposed to the capacitive pad, and is inversely proportional to the distance of the user's limb to the capacitive sensor 50. According to one embodiment, each sensor 50 is excited with a train of voltage pulses via pulse width modulation (PWM) until the sensor is charged up to a set voltage potential. This charges the receive electrode to a known voltage potential. The cycle is repeated until the voltage across the measurement capacitor reaches a predetermined voltage. Placing a user's finger on the touch surface of the sensor 50 introduces external capacitance that increases the amount of charge transferred each cycle, thereby reducing the total number of cycles required for the measurement capacitance to reach the predetermined voltage. The user's finger causes the change in sensor charge pulse count to increase since this value is based on the initialized reference count minus the sensor reading.

Referring to FIG. 7, as the user's finger slides across the pushbutton shifter interface 24, the finger enters successive activation fields associated with the capacitive sensors 50 on each of the pushbutton keys 30 which generates signals 60A-60E corresponding to the five capacitive sensors 50 on the five pushbutton keys 30. Thus, a linear swipe of the finger across the pushbutton shifter interface 24 results in the signal pattern shown. When the user pauses the finger on one of the pushbutton keys 30, the paused signal pattern for signal 60B results as is shown in FIG. 8. When the user pauses and further depresses one of the pushbutton keys 30, the signal pattern 60B shown in FIG. 9 is provided. As seen in FIG. 9, signal 60B results when the user pushes on the key at point 62 which causes a spike in the signal 60B. It should be appreciated that the control circuitry compares each of the signals 60A-60E with a threshold and determines the detection of a user's finger in contact or close proximity (e.g., within 1 mm) when the signal exceeds the threshold. When one or more of the signals exceeds the threshold, a user interfacing with the pushbutton shifter interface 24 is detected which may cause the assembly 25 with the pushbutton keys 30 moving to a forward use position. In addition, when any of the signals detect a threshold greater than the threshold, the display of the PRNDL modes is displayed to the user on the display 22 such that the user is presented with an image representation of which key 30 the finger is currently interfacing with. Further, it should be appreciated that the control circuitry may determine when a signal, such as signal 60B exceeds an activation threshold due to a spike at point 62 when a user presses on the corresponding key and may use the detected press at point 62 to confirm that a user is pressing on the pushbutton key as a confirmation of key actuation. Thus, the capacitive sensors 50 may also serve to provide a reductant confirmation of the user intending to actuation a pushbutton key 30.

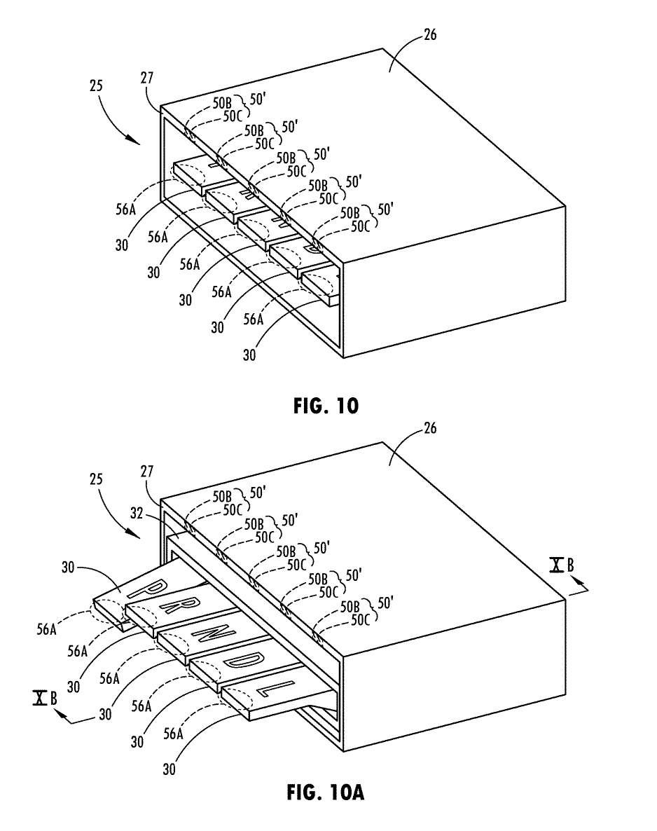

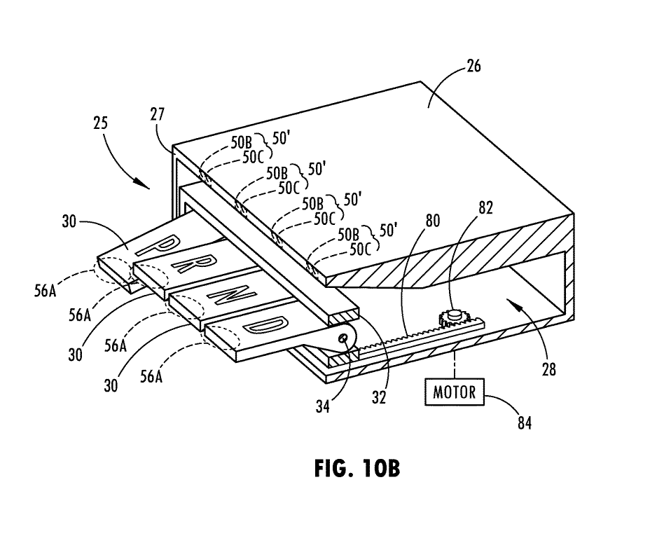

Referring to FIGS. 10-10B, the pushbutton shifter interface 24 is further illustrated employing a plurality of infrared sensors for sensing a user interfacing with the pushbutton keys 30, according to another embodiment. In FIG. 10, the pushbutton keys 30 are shown partially extending from the housing 26 which forms an overhang surface 27 generally spaced above the pushbutton keys 30 such that there is space between the housing 26 and keys 30 for a user's finger to contact the top outer end of the pushbutton keys 30. The infrared sensing arrangement includes infrared sensors 50′ having a plurality of infrared transmitters 50B located in the overhang surface 27 of the housing 26 and on the underside arranged to emit an infrared beam downward onto the corresponding pushbutton keys 30 on infrared sensing area 50A. The infrared sensors 50′ also have a plurality of infrared receivers 50C are located in the overhang surface 27 in a position on the underside and oriented to sense a return infrared signal in the infrared sensing area 50A from the corresponding infrared transmitter 50B and pushbutton keys 30. The infrared transmitters 50B and receivers 50C are arranged to sense the presence of an object, such as a user's finger, on the infrared sensing area 56A on the corresponding keys 30. Accordingly, as a user contacts or slides a finger across a surface of the pushbutton shifter interface 24, the respective infrared sensors 50′ will detect the presence of the finger on each of the keys 30. In response to detecting the presence of a finger, the pushbutton shifter interface 24 may be actuated to a use position and a display of the position of the finger with respect to particular keys may be displayed on display 22.

With reference to FIG. 10B, the pushbutton shifter interface 24 shown in FIGS. 10A and 10B is further illustrated having a linear actuator for actuating the plurality of keys 30 between the outward use position shown in FIG. 10A and the stowed position shown in FIG. 10. The actuation may be achieved by employing a motor 84 driving a gear 82 engaging toothed arm 80 that moves in concert with the movable assembly 25 containing the pushbutton keys 30, according to one embodiment. It should be appreciated that other actuation mechanisms such as a linear set screw or a preloaded spring with an air damper may be employed to actuate the movable assembly 25 of the pushbutton shifter interface 24 between the use and stowed positions. In one example, the assembly 25 moves one to three inches between the stowed and use positions.

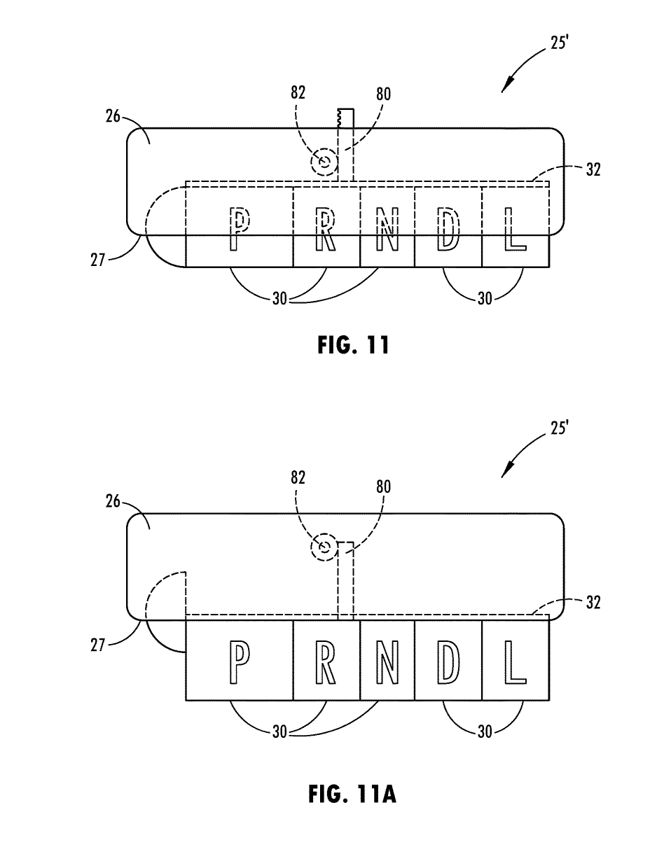

Referring to FIGS. 11 and 11A, linearly actuated pushbutton shifter interface 24′ is further shown in a stowed positon in FIG. 11 and a forward use position in FIG. 11A. In the stowed position, the pushbutton keys 30 are shown extending partially forward of the overhang surface 27 of housing 26 such that a user's fingers may contact to interface with each of the pushbutton keys 30. Upon sensing the user interfacing with one or more of the pushbutton keys 30, the pushbutton shifter interface 24 in response to the sensed proximity sensor sensing a user, actuates the movable assembly 25 with pushbutton keys 30 forward to the use positon shown in FIG. 11A. In this use positon, a user may freely interface with and activate one or more of the pushbutton keys 30 to select a driving mode of the vehicle. When the driver has completed interfacing with the pushbutton shifter interface 24 or after a certain time has expired, the pushbutton keys 30 may be retracted to the stowed position shown in FIG. 11. The linear action of movable assembly 25 may be achieved by a motor driving gear 82 and toothed arm 80, according to one embodiment.

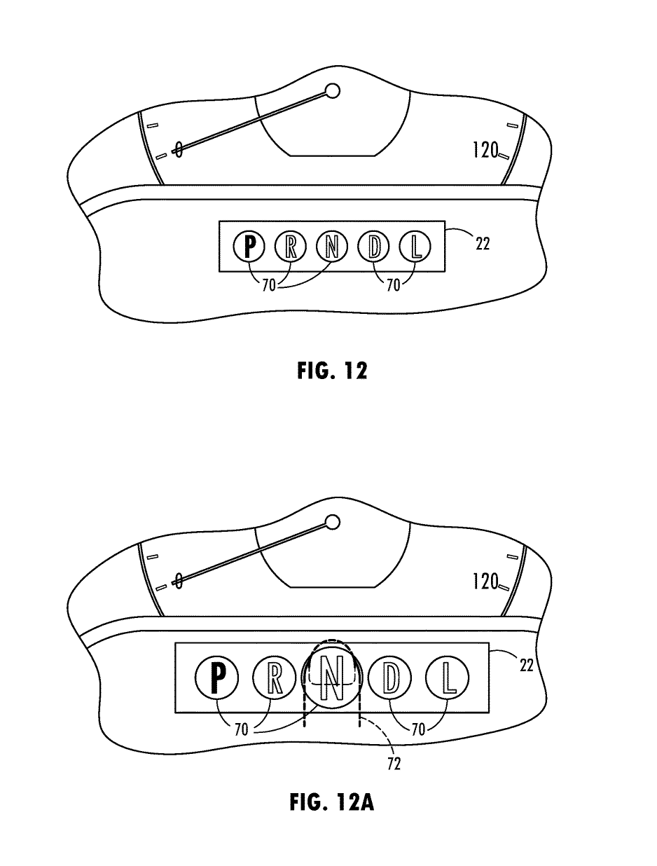

Referring to FIGS. 12 and 12A, the display 22 presented in the instrument cluster 16 of the vehicle 10 is illustrated in greater detail. As seen in FIG. 12, the display 22 is a digital display that provides an indication in the form of icons 70 for representing each of the selectable positions of the vehicle mode which include P, R, N, D, and L icons. When a user is detected by the proximity sensors interfacing with the pushbutton shifter interface 24, the display 22 is controlled to provide enlarged icons and an indication of which pushbutton key 30 a user is interfacing with. In the example shown, an icon 72 of a finger 72 is shown in FIG. 12A overlaid onto the icon 70 showing the key 30 that the user is currently detected to be interfacing with. In addition, the key 30 that the user is interfacing with is shown as an enlarged image of the icon that is larger and therefore move prominent than the other icons so that the driver of the vehicle may readily ascertain which key his finger is interfacing with without distracting the driver. It should be appreciated that the display 22 may further illuminate the selected key in a brighter color or a different color and may provide other types of icons or indications representative of the mode that the vehicle driver is currently interfacing with and the location of the user's finger. While display 22 is shown in the instrument cluster 16, it should be appreciated that display 22 may be located elsewhere on the vehicle.

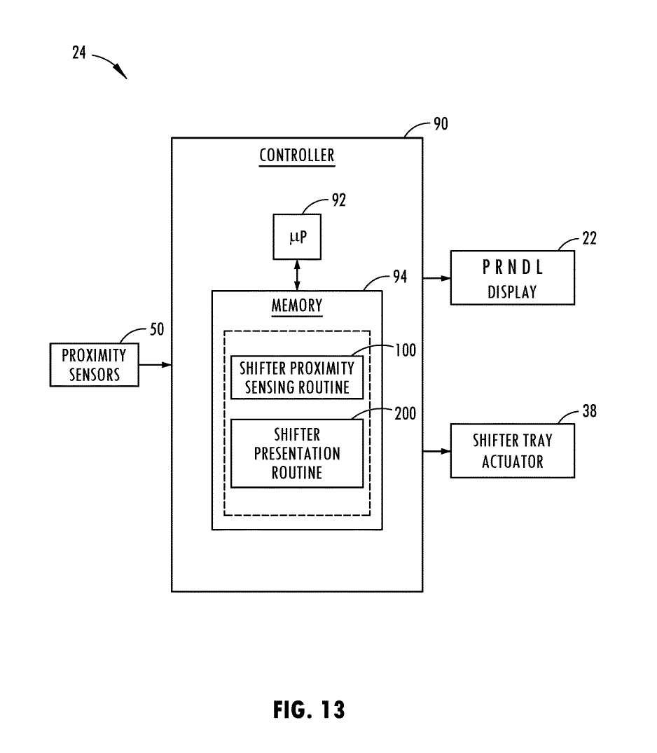

The pushbutton shifter interface 24 may employ a controller 90 as shown, according to one embodiment in FIG. 13. In this arrangement the controller 90 is shown having control circuitry in the form of a microprocessor 92 and memory 90. It should be appreciated that other control circuitry including analog and/or digital control circuitry may be employed. Stored within the memory 94 is a shifter proximity sensing routine 100 and a shifter presentation routine 200. The controller 90 receives signals from each of the proximity sensors 50 associated with the pushbutton keys 30. The controller 90 processes the proximity sensor inputs and generates outputs that are provided to the PRNDL display 22 and to the shifter tray actuator 38 based on processing of the routines 100 and 200. The shifter proximity sensing routine 100 detects a user contacting or in close proximity to the pushbutton keys 30 and controls the display 22 to display a representation of the pushbutton key 30 that is in close proximity to the user's finger. The shifter presentation routine 200 detects a user contacting or in close proximity to the pushbutton shifter interface 24 and actuates the shifter tray or movable assembly between a use position and a stowed position.

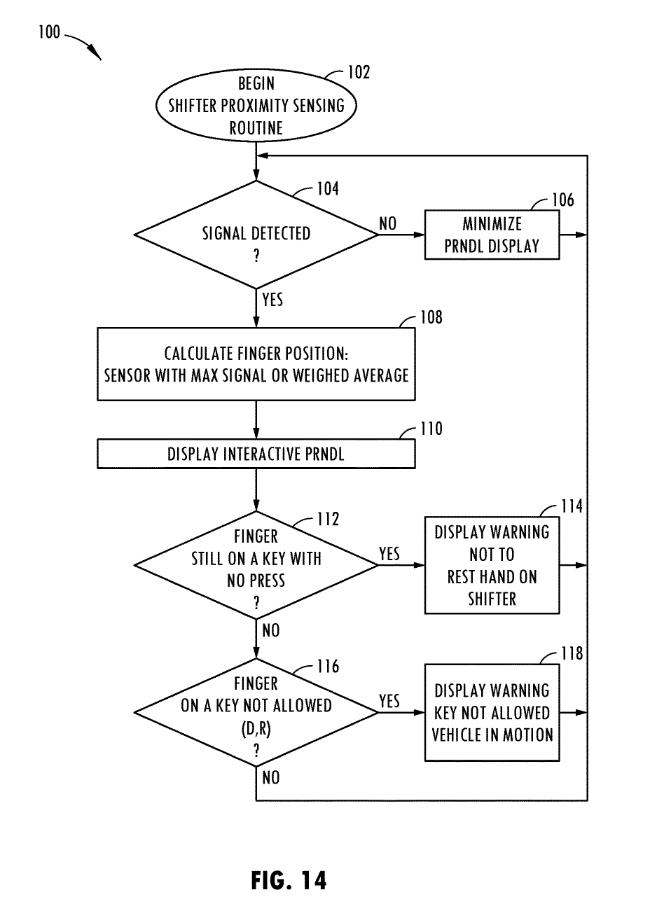

Referring to FIG. 14, the shifter proximity sensing routine 100 is illustrated beginning at step 102 and proceeding to decision step 104 to determine if a proximity sensor signal of a sufficient amplitude has been detected. If a signal of sufficient amplitude has not been detected, the PRNDL display is minimized at step 106 before returning. In the minimized state, the display provides a normal size read-out of the available operating modes PRNDL and highlights the current operating mode with a lighted color or increased lighting. If a signal has been detected which is indicative of a user in contact or close proximity with one or more of the keys, routine 100 proceeds to step 108 to calculate the finger position that has been detected. The position of the finger may be calculated with a sensor using a maximum signal or a weighted average of signals. Next, at step 110, the display displays the current position of the finger so the driver of the vehicle may readily view the location of his finger on the display relative to the pushbutton keys. At decision step 112, routine 100 determines if the finger is still on a pushbutton key with no press of the pushbutton and, if so, displays a warning to the driver not to rest the hand on the shifter at step 114 before returning to step 104. If there is no finger on a pushbutton key with no press, routine 100 proceeds to decision step 116 to determine if a finger is on a pushbutton key that is not allowed, such as attempting to place the vehicle in a vehicle reverse mode while the vehicle is moving forward in the opposite direction. If a finger is detected on a key that is not allowed, then routine 100 displays a warning to the driver that the key is not allowed and the vehicle is in motion at step 118 before returning to step 104. Otherwise, routine 100 returns to step 104.

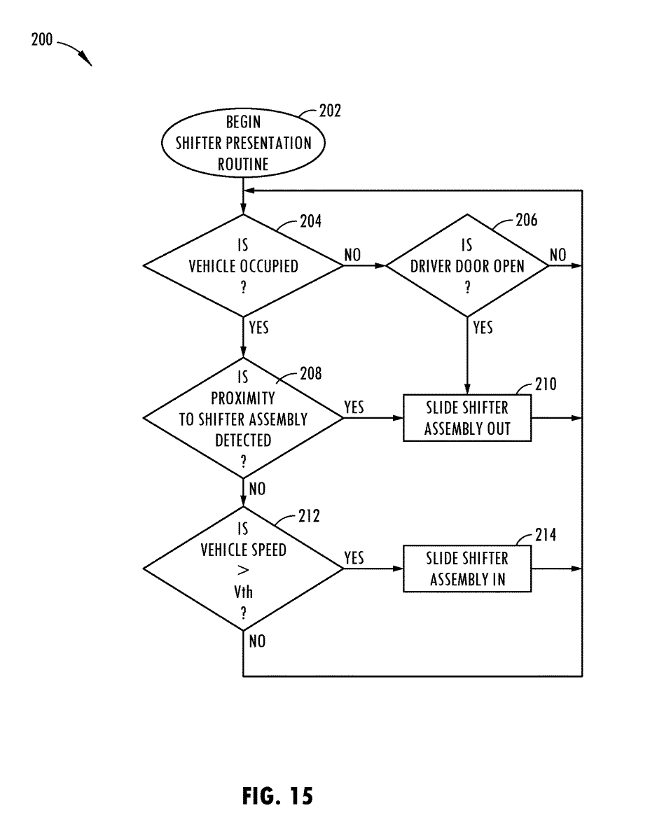

Referring to FIG. 15, the shifter presentation routine 200 is illustrated beginning at step 202 and proceeding to decision step 204 to determine if the vehicle is occupied. If the vehicle is not occupied, routine 200 proceeds to decision step 206 to determine if the driver door is open and, if not, returns to step 204. If the driver door is open, the routine 200 proceeds to step 210 to slide the shifter assembly out to a forward use position before returning to step 204. By sliding the shifter assembly out to a use position when the vehicle door is open and the vehicle is not occupied, the pushbutton keys of the pushbutton shifter interface 204 are automatically and conveniently presented to the driver of the vehicle as the driver enters the vehicle to allow the driver to initially interface therewith and input a desired operating mode of the vehicle.

If the vehicle is occupied, routine 200 proceeds to decision step 208 to determine if user proximity to the shifter is detected. If there is user contact or close proximity to the pushbutton shifter interface by a user detected, routine 200 then proceeds to step 210 to slide the shifter assembly out to a forward use position before returning to step 204. Accordingly, whenever a proximity sensor is detected interfacing by a driver of the vehicle when the vehicle is occupied, the movable assembly of the pushbutton shifter interface is moved to the forward use position. If there is no user proximity to the shifter detected, routine 200 proceeds to decision step 212 to determine if the vehicle speed is greater than a predetermined threshold Vth and, if so, slides the movable shifter assembly in to the stowed position at step 214 before returning to step 204. Accordingly, if the vehicle speed is great enough, such as greater than ten miles an hour, the movable assembly of the pushbutton shifter interface 24 is moved to the stowed position. Otherwise, routine 200 returns to step 204.

Accordingly, the pushbutton shifter interface 24 advantageously detects a user interfacing with the pushbutton keys 30 and, in response, moves the keys to a forward use position that is more convenient for an operator of the vehicle to use. Additionally, the pushbutton shifter interface 24 further displays on a display 22 the position of the user's finger relative to the pushbutton keys 30 in a manner that is easy to view and not distractive to the driver of the vehicle 10.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A pushbutton shifter interface comprising:
a movable assembly supporting a plurality of pushbutton keys actuatable to input a vehicle operating mode;
a proximity sensor arrangement configured to sense a user proximate the pushbutton keys; and
an actuator actuating the movable assembly to a use position in response to sensing the user proximate to the pushbutton keys in a stowed position.

2. The pushbutton shifter interface of claim 1 further comprising a cover at least partially overlying the plurality of pushbutton keys.

3. The pushbutton shifter interface of claim 1, wherein the actuator pivots the movable assembly to a use position.

4. The pushbutton shifter interface of claim 1, wherein the actuator moves the movable assembly forward relative to a cover overlying at least a portion of the proximity sensors.

5. The pushbutton shifter interface of claim 1, wherein the movable assembly moves forward toward the user to the use position.

6. The pushbutton shifter interface of claim 1, wherein the plurality of proximity sensors comprises a plurality of capacitive sensors.

7. The pushbutton shifter interface of claim 1, wherein the plurality of proximity sensors comprises a plurality of infrared sensors.

8. The pushbutton shifter interface of claim 1 further comprising a display for displaying a sensed location of a finger of the user relative to the plurality of pushbutton keys.

9. A pushbutton shifter interface comprising:
a rotating assembly supporting a plurality of pushbutton keys actuatable to input a vehicle operating mode;
a proximity sensor arrangement configured to sense a user proximate the pushbutton keys; and
an actuator actuating the rotating assembly to a use position in response to sensing the user proximate to the pushbutton keys in a stowed position, wherein the actuator pivots the movable assembly to a use position.

10. The pushbutton shifter interface of claim 9 further comprising a cover at least partially overlying the plurality of pushbutton keys.

11. The pushbutton shifter interface of claim 9, wherein the actuator moves the rotating assembly forward relative to a cover overlying at least a portion of the proximity sensors.

12. The pushbutton shifter interface of claim 9, wherein the movable assembly moves forward toward the user to the use position.

13. The pushbutton shifter interface of claim 9, wherein the plurality of proximity sensors comprises a plurality of capacitive sensors.

14. The pushbutton shifter interface of claim 9, wherein the plurality of proximity sensors comprises a plurality of infrared sensors.

15. The pushbutton shifter interface of claim 9 further comprising a display for displaying a sensed location of the user relative to the plurality of pushbutton keys.
